(19) United States
(12) Patent Application Publication
(10) Pub. No.: US 2019/0013019 A1
(43) Pub. Date: Jan. 10, 2019

(54) SPEAKER COMMAND AND KEY PHRASE MANAGEMENT FOR MULI -VIRTUAL ASSISTANT SYSTEMS

(71) Applicant: Intel Corporation, Santa Clara, CA (US)

(72) Inventor: Sean J. Lawrence, Bangalore (IN)

(21) Appl. No.: 15/645,366

(22) Filed: Jul. 10, 2017

(51) Int. Cl. G10L 15/22; G10L 15/18; G10L 15/30

(52) U.S. Cl. CPC G10L 15/22; G10L 15/1815; G10L 2015/088; G10L 2015/223; G10L 15/30

(57) ABSTRACT

Systems, apparatuses and methods are described for automatically managing a plurality of virtual assistants that may be simultaneously available on the same device and wherein each assistant may be preferred for a particular task. Selected assistants may be activated by substituting their key phrase when another was actually uttered.

### TECHNICAL FIELD

Embodiments generally relate to virtual assistants and, more particularly, to managing a plurality of key-phrase voice activated virtual assistants found, for example, on many smart devices.

### BACKGROUND

Virtual assistants are widely available today, for example, Alexa, Siri, Cortana and Real Speech, to name a few. Each of these assistants come with their own benefits. For example, some that are primarily cloud based come with the benefit of cloud infrastructure access and functionalities as well as the benefit of larger vocabulary due to updates and learning from the cloud infrastructure. In contrast, those that are primarily local to the device may provide the benefit of data security as conversations and speech utterances aren't unnecessarily sent to the cloud.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram showing a smart device having access to a plurality of virtual assistants;

FIG. 2 is a block diagram of a smart device having a voice assistant abstraction layer to automatically select one of the virtual assistants according to one embodiment;

FIG. 3 block diagram showing a more detailed view of the voice assistant abstraction layer according to one embodiment;

FIGS. 4-6 are block diagrams illustrating the voice assistant abstraction layer selecting different assistants based on task intent and rules.

### DESCRIPTION OF EMBODIMENTS

Embodiments are directed to a system and method for a combined usage and management of a plurality of virtual assistants that may be simultaneously available on the same device. Each of the assistants may have benefits that may be preferred for a particular task. A virtual assistant may be a software agent that runs on a variety of platforms, such as smart phones, tablets, portable computers, and more recently so-called home smart speakers that sit in a room and continuously listen for tasks and services that it may perform for the user.

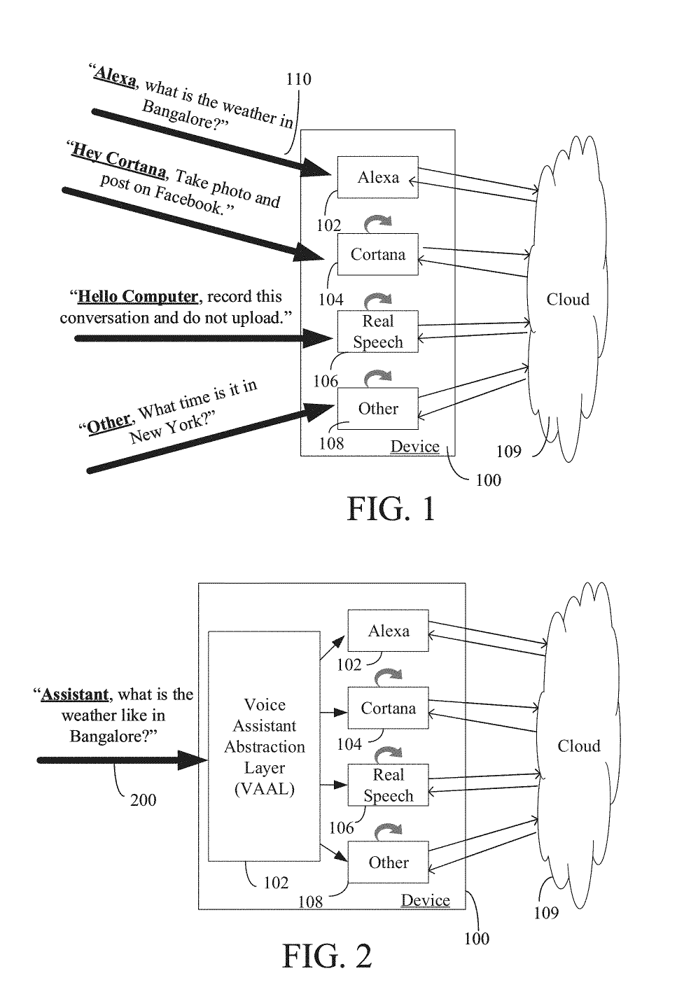

Referring now to FIG. 1, there is shown a device 100 that may have access to multiple virtual assistants. For illustrative purposes only, several common commercially available virtual assistants are mentioned, however there are many others available and likely many more yet to become available, any of which may be useful for embodiments of the invention.

Each of the virtual assistants shown, Alexa 102, Cortana, 104, Real Speech 106 and Other 108 (which simply represents any generic assistant) may be activated using a key phrase. Each assistant, 102-108, listens for an utterance of their key phrase and, when the key phrase is recognized, the assistant tries to execute whatever task or service request follows. For example, a microphone on the device 100 may hear “Alexa, what is the weather in Bangalore?”. Only Alexa 102, should try to respond to the question that follows the key-phrase utterance of “Alexa” 110. Similarly, Cortana 104 may respond to its key phrase “Hey Cortana” 112 and Real Speech 114 may respond to “Hello Computer” 114. In this example, Alexa 102 may go to the cloud 109, where remote servers process the utterance, search for the “weather in Bangalore” and deliver the current Bangalore weather conditions to the user. Key-phrases are typically factory set but may be changed by the user or the programmers.

In one embodiment multiple assistants 102-108, may be available to complement each other for their various benefits. However, remembering the different functionalities and benefits for a particular assistant may be cumbersome particularly to the lay user or average user. Embodiments include a two part solution to improve the user experience. In the remaining FIGS. like items are labeled where possible with like reference numerals for simplicity and not necessarily described again.

Referring to FIG. 2, embodiments may comprise an abstraction layer that will be referred to as the Voice Assistant Abstraction Layer (VAAL) 120. The VAAL 120 may be communicatively connected to a plurality of assistants 102-108. The VAAL 120 intercepts utterances 200 comprising speech task requests and determines the high level intent of the user for the requested task. Thereafter, the VAAL 120 selects the best assistant 102-108 for the task. Which assistant 102-108 is best for a task may be determined based on pre-defined rules or preferences customized by the user. All utterances 200 heard by the device 100 may be modified by the VAAL 120 to remove any key-phrases a user may have uttered and substitute therefor the appropriate key phrase for the assistant 102-108 selected by the VAAL 120.

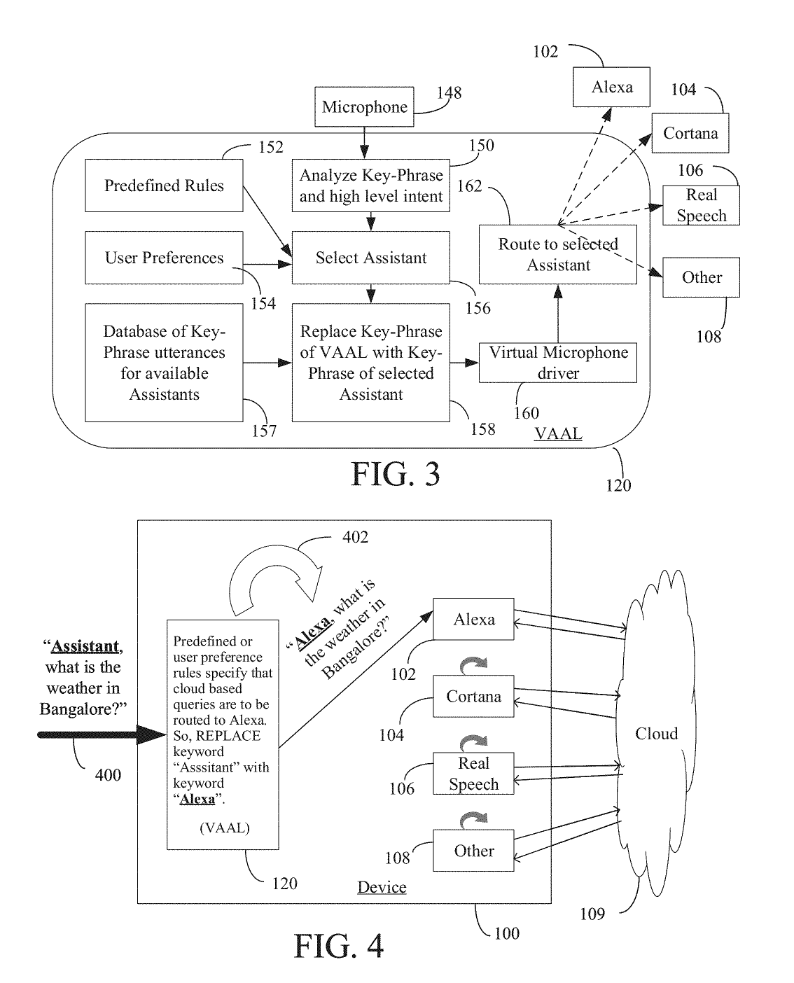

Referring now to FIG. 3, there is shown one embodiment of the VAAL 120. A microphone 148, which may be part of the device 100 (FIG. 2), delivers a signal to a speech analysis circuit 150. The speech analysis circuit 150 analyzes the speech signal for any key phrases. When a key phrase is detected it may use natural language processing or other techniques to determine the high level intent of any utterance that follows the key phrase.

The high level intent may simply be determining if the utterance involves a request for a task that may be processed locally or is a task that would involve accessing outside services on the cloud. For example, the task may be “what time is it in New York?” or “Wake me up at 7 AM” or “add bread to my shopping list” or “record this conversation”. These may be calculated and executed locally. Local calculation and execution may be faster, plus, for privacy reasons perhaps the user does not want the cloud to know what time they get up or what they buy at the grocery store or have access to a recorded conversation.

The task may be to “take a photo and share it on Facebook” or “find the cheapest direct flight to New York next Friday”. These types of tasks likely require non-local calculations and access to social media servers and therefore may be better suited for the cloud.

The task may be to “lower the temperature in my house to 72 degrees” or “turn on the lawn sprinklers and let them run for an hour”. These types of tasks may be accomplished locally through a home network or may use the cloud if you are trying to do it from the other side of the world.

All the above high-level intent may be stored as predefined rules at predefined rule circuit 152. These rules may be determined by the designer knowing which virtual assistant 102-108 is best suited for the high level intent of the task. For instance, there may be a rule that for tasks in the first set of examples that may be done locally, to always use Real Speech 106 because it performs local tasks well.

For the second set of examples that need the cloud, there may be a rule that says to always use Alexa 102 or always use Cortana 104. For the third set of examples that can be performed efficiently either locally or with the cloud, a user preference circuit 154 may be provided to allow the user to make or override the rules as to which assistant 102-108 to use.

Based on the predefined rules 152 or the user preferences 154 an assistant selection circuit 156 may be used to determine which assistant 102-108 to use. The VAAL 120 may further contain a database of key-phrases 157 for the available assistants 102-108. A key phrase replacement circuit 158 may delete the actual key phrase uttered by the user and substitute therefor the key phrase for the assistant 102-108 determined by the assistant selection module 156. One way this may be done is with a virtual microphone driver 160 that may route 162 the key phrase and the task to the assistants 102-108. The output of the virtual microphone driver 160 may go to all the assistants 102-106, however, only the selected assistant will respond since only it will recognize the substituted key phrase. In other words, the selected assistant 102-104 may be “tricked” into responding since it's key phrase was inserted into the user's utterance whether or not it was the actual key phrase uttered.

FIGS. 4-6 are block diagrams that demonstrate the above described VAAL 120 in operation for three different scenarios. The VAAL 120 may have its own key phrase 400. In these examples its simply the word “Assistant”, but it could be anything including one of the key phrases already used by one of the available assistants 102-104. In other embodiments if the user uses the actual key phrase of one of the assistants 102-108, the VAAL 120 may simply pass the key phrase through thus effectively overriding the VAAL 120.

In FIG. 4, the routing of cloud based commands to the Alexa assistant 102 is shown. Once the Alexa assistant 102 is identified for use by VAAL 120, the VAAL 120 replaces the VAAL's keyword “Assistant” 400, which is now the only key phrase the user may need to remember, with the key phrase for the selected assistant—in this case is “Alexa” 402.

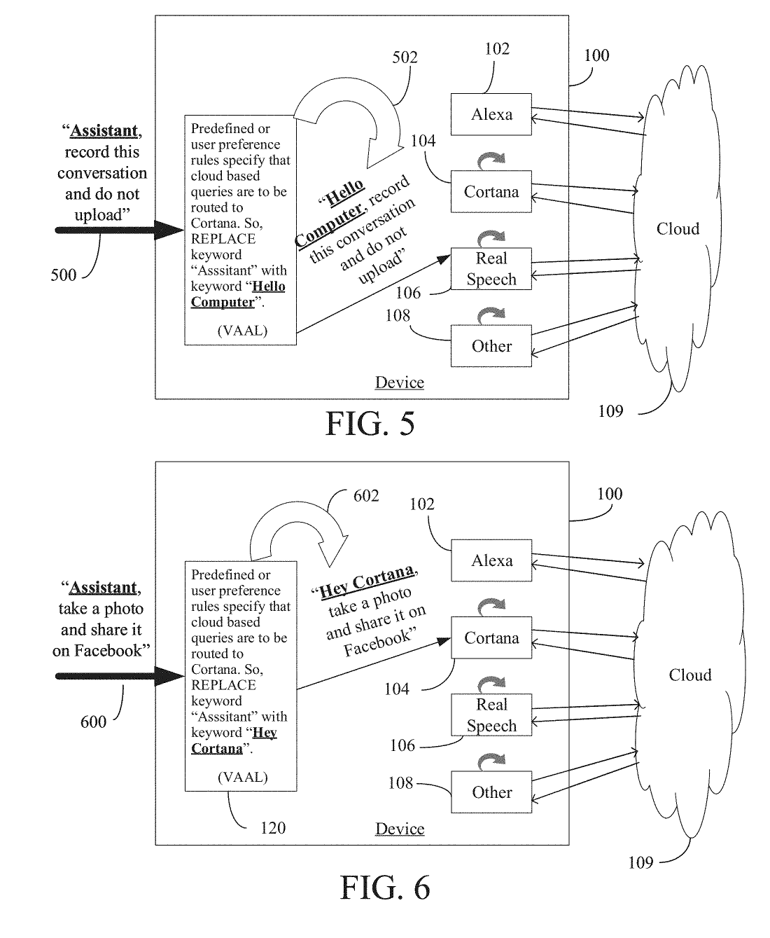

Similarly, in FIG. 5, where the utterance may be locally executed, the Real Speech assistant key phrase “Hello Computer” 502 is inserted into the utterance 500 and passed to the assistants 102-108, but only the Real Speech assistant 106 will respond.

Likewise, in FIG. 6, where the utterance 600 may need the cloud, the Cortana assistant key phrase “Hey Cortana” 602 is inserted into the utterance 500 and passed to the assistants 102-108, but only the Cortana assistant 104 will respond.

Embodiments of each of the above system components may be implemented in hardware, software, or any suitable combination thereof. For example, hardware implementations may include configurable logic such as, for example, programmable logic arrays (PLAs), FPGAs, complex programmable logic devices (CPLDs), or in fixed-functionality logic hardware using circuit technology such as, for example, ASIC, complementary metal oxide semiconductor (CMOS) or transistor-transistor logic (TTL) technology, or any combination thereof. Alternatively, or additionally, these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system applicable/appropriate programming languages, including an object-oriented programming language such as PYTHON, PERL, JAVA, SMALLTALK, C++, C# or the like and conventional procedural programming languages, such as the “C” programming language or similar programming languages.

### Additional Notes and Examples

Example 1 may include an apparatus, comprising, a smart device, a microphone communicatively connected to the smart device to listen for utterances, at least a first virtual assistant and a second virtual assistant accessible by the smart device, the first virtual assistant to respond to an utterance of a first key phrase and the second virtual assistant to respond to a second key phrase, where the first key phrase is different from the second key phrase, and an abstraction layer circuit responsive to an utterance of a third key phrase, the abstraction layer circuit to replace the third key phrase with one of the first key phrase or the second key phrase and to communicate it to the first virtual assistant and the second virtual assistant.

Example 2 may include the apparatus as recited in example 1, further comprising, a natural language processing circuit to analyze utterances for intent, and a rules circuit to store rules to select one of the first virtual assistant or second virtual assistant based on the intent.

Example 3 may include the apparatus as recited in example 2, further comprising, a user preference circuit where a user defines rules.

Example 4 may include the apparatus as recited in example 2, wherein the intent comprises one of a task to be carried out locally or to be carried out via a cloud connection.

Example 5 may include the apparatus as recited in example 1, wherein an utterance containing the first key phrase or the second key phrase is unchanged by the abstraction layer.

Example 6 may include the apparatus as recited in example 1, wherein the abstraction layer further comprises, a database including key phrase utterances for all available virtual assistants.

Example 7 may include a method, comprising, providing at least a first virtual assistant and a second virtual assistant accessible by the smart device, wherein the first virtual assistant to respond to an utterance of a first key phrase and the second virtual assistant to respond to a second key phrase, where the first key phrase is different from the first key phrase, listening for an utterance of a third key phrase followed by a task, replacing the third key phrase with one of the first key phrase or second key phrase, and communicating the replaced key phrase and the task to the first virtual assistant and a second virtual assistant.

Example 8 may include the method as recited in example 7, further comprising, natural language processing the task to determine intent, and applying the intent to predefined rules to select the first key phrase or the second key phrase for the replacement step.

Example 9 may include the method as recited in example 8, further comprising, allowing a user to define the rules.

Example 10 may include the method as recited in example 8, wherein the intent is comprises determining if the task is to be carried out locally or to be carried out via a cloud connection.

Example 11 may include the method as recited in example 18, wherein an utterance containing the first key phrase or the second key phrase is unchanged by the abstraction layer.

Example 12 may include the method as recited in example 7, further comprising, storing in a database key phrase utterances for all available virtual assistants.

Example 13 may include at least one computer readable storage medium comprising a set of instructions which, when executed by a computing device, cause the computing device to perform the steps as recited in any of examples 7-12.

Example 14 may include a system, comprising, a smart device, a microphone communicatively connected to the smart device to listen for utterances, at least a first virtual assistant and a second virtual assistant accessible by the smart device, the first virtual assistant to respond to an utterance of a first key phrase and the second virtual assistant to respond to a second key phrase, where the first key phrase is different from the second key phrase, and an abstraction layer circuit responsive to an utterance of a third key phrase, the abstraction layer circuit to replace the third key phrase with one of the first key phrase or the second key phrase communicated to the first virtual assistant and the second virtual assistant, and a cloud connection to allow the at least a first virtual assistant or the second virtual assistant to communicate with the cloud.

Example 15 may include the system as recited in example 14, further comprising, natural language processing circuit to analyze utterances for intent, and a rules circuit to store rules to select one of the first virtual assistant or second virtual assistant based on the intent.

Example 16 may include the system as recited in example 15, further comprising, a user preference circuit where a user defines rules.

Example 17 may include the system as recited in example 15, wherein the intent comprises one of a task to be carried out locally or to be carried out via a cloud connection.

Example 18 may include an apparatus, comprising, means for providing at least a first virtual assistant and a second virtual assistant accessible by the smart device, wherein the first virtual assistant to respond to an utterance of a first key phrase and the second virtual assistant to respond to a second key phrase, where the first key phrase is different from the first key phrase, means for listening for an utterance of a third key phrase followed by a task, replacing the third key phrase with one of the first key phrase or second key phrase, and means for communicating the replaced key phrase and the task to the first virtual assistant and a second virtual assistant.

Example 19 may include the apparatus as recited in example 18, further comprising, means for natural language processing the task to determine intent, and means for applying the intent to predefined rules to select the first key phrase or the second key phrase for the replacement step.

Example 20 may include the apparatus as recited in example 19, further comprising, means for allowing a user to define the rules.

Example 21 may include the apparatus as recited in example 18, wherein the intent is comprises determining if the task is to be carried out locally or to be carried out via a cloud connection.

Example 22 may include the apparatus as recited in example 19, wherein an utterance containing the first key phrase or the second key phrase is unchanged by the abstraction layer.

Example 23 may include the apparatus as recited in example 18, further comprising, means for storing in a database key phrase utterances for all available virtual assistants.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

I claim:

1. An apparatus, comprising:
a smart device;
a microphone communicatively connected to the smart device to listen for utterances;
at least a first virtual assistant and a second virtual assistant accessible by the smart device, the first virtual assistant to respond to an utterance of a first key phrase and the second virtual assistant to respond to a second key phrase, where the first key phrase is different from the second key phrase; and
an abstraction layer circuit responsive to an utterance of a third key phrase, the abstraction layer circuit to replace the third key phrase with one of the first key phrase or the second key phrase and to communicate it to the first virtual assistant and the second virtual assistant.

2. The apparatus as recited in claim 1, further comprising:
a natural language processing circuit to analyze utterances for intent; and
a rules circuit to store rules to select one of the first virtual assistant or second virtual assistant based on the intent.

3. The apparatus as recited in claim 2, further comprising:
a user preference circuit where a user defines rules.

4. The apparatus as recited in claim 2, wherein the intent comprises one of a task to be carried out locally or to be carried out via a cloud connection.

5. The apparatus as recited in claim 1, wherein an utterance containing the first key phrase or the second key phrase is unchanged by the abstraction layer.

6. The apparatus as recited in claim 1, wherein the abstraction layer further comprises:
a database including key phrase utterances for all available virtual assistants.

7. A method, comprising:
providing at least a first virtual assistant and a second virtual assistant accessible by the smart device, wherein the first virtual assistant to respond to an utterance of a first key phrase and the second virtual assistant to respond to a second key phrase, where the first key phrase is different from the first key phrase;
listening for an utterance of a third key phrase followed by a task;
replacing the third key phrase with one of the first key phrase or second key phrase; and
communicating the replaced key phrase and the task to the first virtual assistant and a second virtual assistant.

8. The method as recited in claim 7, further comprising:
natural language processing the task to determine intent; and
applying the intent to predefined rules to select the first key phrase or the second key phrase for the replacement step.

9. The method as recited in claim 8, further comprising:
allowing a user to define the rules.

10. The method as recited in claim 8, wherein the intent is comprises determining if the task is to be carried out locally or to be carried out via a cloud connection.

11. The method as recited in claim 8, wherein an utterance containing the first key phrase or the second key phrase is unchanged by the abstraction layer.

12. The method as recited in claim 7, further comprising:
storing in a database key phrase utterances for all available virtual assistants.

13. At least one computer readable storage medium comprising a set of instructions which, when executed by a computing device, cause the computing device to perform the steps of:
providing at least a first virtual assistant and a second virtual assistant accessible by the smart device wherein the first virtual assistant to respond to an utterance of a first key phrase and the second virtual assistant to respond to a second key phrase, where the first key phrase is different from the first key phrase;
listening for an utterance of a third key phrase followed by a task;
replacing the third key phrase with one of the first key phrase or second key phrase; and
communicating the replaced key phrase and the task to the first virtual assistant and a second virtual assistant.

14. The medium as recited in claim 13, further comprising:
natural language processing the task to determine intent; and
applying the intent to predefined rules to select the first key phrase or the second key phrase for the replacement step.

15. The medium as recited in claim 14, further comprising:
allowing a user to define the rules.

16. The medium as recited in claim 14, wherein the intent is comprises determining if the task is to be carried out locally or to be carried out via a cloud connection.

17. The medium as recited in claim 14, wherein an utterance containing the first key phrase or the second key phrase is unchanged by the abstraction layer.

18. The medium as recited in claim 13, further comprising:
storing key phrase utterances for all available virtual assistants.

19. A system, comprising:
a smart device;
a microphone communicatively connected to the smart device to listen for utterances;
at least a first virtual assistant and a second virtual assistant accessible by the smart device, the first virtual assistant to respond to an utterance of a first key phrase and the second virtual assistant to respond to a second key phrase, where the first key phrase is different from the second key phrase; and
an abstraction layer circuit responsive to an utterance of a third key phrase, the abstraction layer circuit to replace the third key phrase with one of the first key phrase or the second key phrase communicated to the first virtual assistant and the second virtual assistant; and
a cloud connection to allow the at least a first virtual assistant or the second virtual assistant to communicate with the cloud.

20. The system as recited in claim 19, further comprising:
a natural language processing circuit to analyze utterances for intent; and
a rules circuit to store rules to select one of the first virtual assistant or second virtual assistant based on the intent.

21. The system as recited in claim 20, further comprising:
a user preference circuit where a user defines rules.

22. The system as recited in claim 20, wherein the intent comprises one of a task to be carried out locally or to be carried out via a cloud connection.
